(19) United States
(12) Patent Application Publication
(10) Pub. No.: US 2004/0014584 A1
(43) Pub. Date: Jan. 22, 2004

(54) Glass ceramic mass and use thereof

(76) Inventors: Oliver Dernovsek, Munchen (DE); Markus Eberstein, Berlin (DE); Wolfgang Guther, Berlin (DE); Christina Modes, Frankfurt (DE); Gabriele Preu, Munchen (DE); Wolfgang Arno Schiller, Berlin (DE); Barbel Schulz, Berlin (DE); Wolfram Wersing, Bergen (DE)

Correspondence Address: YOUNG & THOMPSON, 745 SOUTH 23RD STREET 2ND FLOOR, ARLINGTON, VA, 22202

(21) Appl. No.: 10/362,942

(22) PCT Filed: Aug. 31, 2001
(86) PCT No.: PCT/DE01/03337

(30) Foreign Application Priority Data
Sep. 1, 2000 (DE) 100 43 194.1

(51) Int. Cl. C03C 14/00; C04B 35/468

(52) U.S. Cl. 501/32; 501/139

(57) ABSTRACT

The invention relates to a glass ceramic mass, comprising at least one oxide ceramic, containing barium, titanium and at least one rare earth metal Rek and at least one glass material, containing at least one oxide with boron and at least one oxide of a rare earth metal Reg. The glass material further contains either an oxide of a tetravalent metal Me4+, or at least one oxide of a pentavalent metal Me5+. A compression of the glass ceramic mass occurs above all by viscous flow. A low vitrification temperature can thus be achieved. Crystallisation products are produced during and/or after the compression. The rare earth oxide and the crystallisation products can be used to pre-determine each of a dielectric material property of the glass ceramic mass in a wide range such as permittivity (15-80), Q (350-5000) and Tf value (±20 ppm/K). The glass ceramic mass is characterised by a vitrification temperature of below 850° C. and can thus find application in LTCC (low temperature cofired ceramics) technology for the integration of a passive electrical component in the volume of a ceramic multi-layer body. Suppression of a lateral shrinkage may be achieved in a composite with a ceramic film blank made from another ceramic material compressed at a higher temperature.

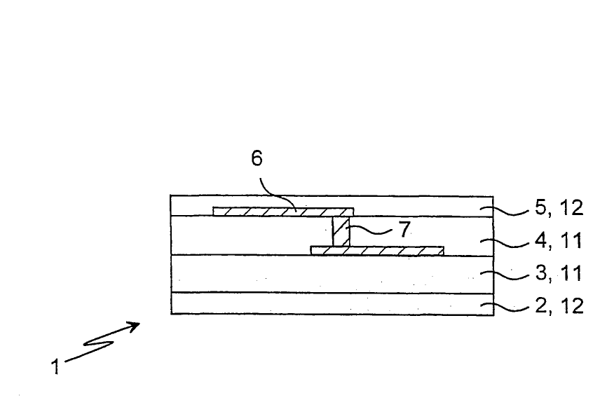

The invention relates to a glass ceramic mass, comprising at least one oxide ceramic, containing barium, titanium and at least one rare earth metal Rek and at least one glass material, containing at least one oxide with boron. In addition, the invention relates to a glass ceramic mass, comprising at least one oxide ceramic, containing barium, titanium and at least one rare earth metal Rek and at least one glass material, containing at least one oxide with boron and at least one oxide with at least one tetravalent metal Me4+. In addition to the glass ceramic masses, a use of the glass ceramic masses is described.

The aforementioned glass ceramic masses are known from U.S. Pat. No. 5,264,403. The oxide ceramic for the glass ceramic mass is manufactured from barium oxide (BaO), titanium dioxide (TiO₂), a trioxide of a rare earth metal (Rek₂O₃) and possibly bismuth trioxide (Bi₂O₃). The rare earth metal Rek is for example neodymium. The oxide ceramic for the aforementioned compound is referred to as microwave ceramic since its dielectric material properties permittivity (εᵣ), quality (Q) and temperature coefficient of frequency (Tf value) are very well suited for use in microwave technology. The glass material in the glass ceramic mass consists of boron trioxide (B₂O₃), silicon dioxide (SiO₂) and zinc oxide (ZₙO). A ceramic proportion of the oxide ceramic in the glass ceramic mass is for example 90% and a glass proportion of the glass material 10%. A compression of the glass ceramic mass occurs at a sintering temperature of about 950° C.

A glass ceramic mass is known from JP 08 073 239 A which consists primarily of a glass proportion of a glass material. The glass material exhibits differing combinations of silicon dioxide, lanthanum trioxide (Ln₂O₃), titanium dioxide, an alkaline earth metal oxide and zirconium dioxide (ZrO₂).

Both glass ceramic masses are suitable for use in LTCC (low temperature cofired ceramics) technology. The LTCC technology is described for example in D. L. Wilcox et al, Proc. 1997 ISAM, Philadelphia, pp. 17 to 23. The LTCC technology is a ceramic multilayer method in which a passive electrical component can be integrated in the volume of a ceramic multilayer body. The passive electrical component is for example an electrical conductor track, a coil, an induction or a capacitor. Integration is achieved, for example, by printing a metal structure corresponding to the component on one or more ceramic film blanks, stacking the printed ceramic film blanks above one another to form a composite and sintering the composite. Since ceramic film blanks are used with a low sintering glass ceramic mass, electrically highly conductive elementary metal MeO with a low melting point such as silver or copper can be sintered in a composite with the ceramic film blank.

An LTCC method is known from WO 00/04577 in which in order to avoid a lateral shrinkage (zero xy shrinkage) during the sintering process the composite is constructed from ceramic film blanks using a first and at least one further glass ceramic mass. The first glass ceramic mass and the further glass ceramic mass compress at different temperatures. The composite is sintered in a two-stage sintering process. The first glass ceramic mass compresses at a lower temperature (e.g. 750° C.). The non-compressing further glass ceramic mass suppresses the lateral shrinkage of the compressing first glass ceramic mass. When compression of the first glass ceramic mass is completed, the further glass ceramic mass is compressed at a higher temperature (e.g. 900° C.). The already compressed first glass ceramic mass now prevents the lateral shrinkage of the further glass ceramic mass compressing at the higher temperature. The first glass ceramic mass compressing at the lower temperature consists primarily of a glass proportion with a glass material which contains barium, aluminum and silicon (barium-aluminum-silicate glass). The further glass ceramic mass compressing at the higher temperature consists primarily of an oxide ceramic of the formal compound Ba₆₋ₓRek₈₊₂ₓTi₁₈O₅₄ (0≦x≦1), where Rek is one of the rare earth metals lanthanum, neodymium or samarium. The ceramic multilayer body obtained as a result of the two-stage sintering process is characterized by a lateral shrinkage (lateral displacement) of ≦2%.

In the case of a glass ceramic mass having a high proportion of ceramic in the oxide ceramic, compression of the glass ceramic mass takes places primarily as a result of reactive liquid phase sintering. During the compression (sintering) process, a liquid glass phase (glass melt) is formed from the glass material. At a higher temperature the oxide ceramic dissolves in the glass melt until a saturation concentration is reached and a separation of the oxide ceramic occurs once again. As a result of the oxide ceramic dissolving and separating out again, the composition of the oxide ceramic and thus also the composition of the glass phase or the glass material can change. For example, one constituent of the oxide ceramic remains in the glass phase after cooling of the glass ceramic mass.

On the other hand, in the case of glass ceramic masses having a relatively high proportion of glass, compression takes places primarily as a result of a viscous flow of the glass melt of the glass material in the range of a softening point T_{soft} of the glass material. In this situation, vitrification takes place below 900° C. The higher the proportion of glass in the glass ceramic mass, the lower the temperature at which the glass ceramic mass compresses. However, the higher the proportion of glass, the lower is the permittivity of the glass ceramic mass. As the proportion of glass increases, the quality and the Tf value of the glass ceramic mass are also influenced in such a way that the glass ceramic mass is no longer suitable, for example, for use in microwave technology applications.

The object of the present invention is to specify a glass ceramic mass which compresses at a temperature below 850° C. and is nevertheless suitable for use in microwave technology.

This object is achieved by specifying a glass ceramic mass comprising at least one oxide ceramic, containing barium, titanium and at least one rare earth metal Rek and at least one glass material, containing at least one oxide with boron and at least one oxide with at least one tetravalent metal Me4+. The glass ceramic mass is characterized by the fact that the glass material contains at least one oxide with at least one rare earth metal Reg. In this situation, in particular, the glass material contains at least one oxide with at least one pentavalent metal Me5+.

This object is also achieved by specifying a glass ceramic mass comprising at least one oxide ceramic, containing barium, titanium and at least one rare earth metal Rek and at least one glass material, containing at least one oxide with boron. This glass ceramic mass is characterized by the fact that the glass material contains at least one oxide with at least one pentavalent metal Me5+ and at least one oxide with at least one rare earth metal Reg. In this situation, in particular, the glass material contains at least one oxide with at least one tetravalent metal Me4+.

The glass ceramic mass is a glass ceramic compound and is independent of its state. The glass ceramic mass can exist as a ceramic green body. With regard to a green body, a film blank for example, a powder of the oxide ceramic and a powder of the glass material can be combined with one another by means of an organic binding agent. It is also conceivable that the glass ceramic mass exists as a powder mixture of the oxide ceramic and the glass material. Furthermore, the glass ceramic mass can exist as a sintered ceramic body. For example, a ceramic multilayer body produced in a sintering process consists of the glass ceramic mass. This ceramic multilayer body can be submitted to a further sintering process or firing process at a higher firing temperature.

The oxide ceramic can be present as a single phase. However, it can also consist of a plurality of phases. It is conceivable, for example, for the oxide ceramic to consist of phases each having a conceivable for one or more parent compounds of an oxide ceramic to be present which are then converted to form the actual oxide ceramic only during the sintering process.

The glass material can likewise be a single phase. For example, the phase is a glass melt consisting of boron trioxide, titanium dioxide and lanthanum trioxide. It is also conceivable for the glass material to consist of a plurality of phases. For example, the glass material consists of a powder mixture of the specified oxides. A joint glass melt is formed from the oxides during the sintering process. A softening point for the glass material is preferably below 800° C. in order to allow the viscous flow at as low a temperature as possible. In particular, it is also conceivable for the glass material to exhibit a crystalline phase. The crystalline phase is formed, for example, by a crystallization product of the glass melt. This means that the glass material is present not only as a glass phase after the sintering process but also in a crystalline form. A crystallization product of this type is lanthanum borate (LaBO₃), for example. In particular, it is also conceivable for the crystallization product or another crystalline component to be added to the glass material prior to the sintering process. The crystallization product and the crystalline component can be used as crystallization seeds.

The composition of the glass ceramic mass is preferably chosen such that the compression occurs by viscous flow as a matter of priority. As a result of viscous flow, compression occurs at a relatively low temperature. A viscosity temperature characteristic crucial to the compression process, which is expressed for example in the glass transition point Tg and in the softening point T_{soft} of the glass material, can be set for example by means of a ratio of the boron trioxide to the oxide of the tetravalent metal Me4+ or to the oxide of the pentavalent metal Me5+.

At the same time, almost independently of the compression temperature, the dielectric material properties of the glass ceramic mass can be varied. Principally as a result of the oxide of the rare earth metal, it is possible to harmonize the dielectric material properties of the glass material with the dielectric material properties of the oxide ceramic. The greater the proportion of lanthanum trioxide in the glass material for example, the higher is the permittivity of the glass material. Moreover, the composition of the oxide ceramic and the composition of the glass material are chosen such that crystallization products are formed during compression (by means of liquid phase sintering for example) and in particular after compression (at higher temperatures). These crystallization products have an advantageous effect on the dielectric material properties of the glass ceramic mass, such that the glass ceramic mass can be used in microwave technology. In this manner, it is possible for example to obtain a glass ceramic mass with a relatively high permittivity of over 15 and with a quality of over 350 at a low compression temperature.

In a special embodiment the oxide ceramic has a formal composition BaRek₂Ti₄O₁₂. The rare earth metal Rek is lanthanum, for example. The oxide ceramic having this composition is particularly well suited as a microwave ceramic. The Tf value of the oxide ceramic lies in the range between −20 ppm/K and +200 ppm/K. By means of a suitable composition and combination of oxide ceramic and glass material it is possible to obtain a low absolute Tf value. If the Tf value of the glass ceramic mass serving as the basis is negative, then for example BaLa₂Ti₄O₁₂, titanium dioxide and/or strontium titanate (SrTiO₃) are used to make a corrective adjustment of the glass ceramic mass towards ±0 ppm/K. However, if the Tf value of the glass ceramic mass serving as the basis is positive, then for example BaSm₂Ti₄O₁₂, aluminum oxide and lanthanum borate (LaBO₃) can be used to adjust the Tf value. The additional oxides which are used for corrective adjustment can be added before sintering of the glass ceramic mass takes place. However, these oxides can also be the aforementioned crystallization products.

The rare earth metal Reg is present for example as the trioxide Reg₂O₃. By using the oxide of the rare earth metal Reg, it is possible match the permittivity of the glass material, which contributes to the permittivity of the overall glass ceramic mass, to the permittivity of the oxide ceramic. A glass ceramic mass exhibiting a permittivity of 15 to 80 or even higher is thus accessible.

In particular, the rare earth metal Rek and/or the rare earth metal Reg are selected from the group comprising lanthanum and/or neodymium and/or samarium. Other lanthanides or even actinides are also conceivable. The rare earth metals Rek and Reg can be identical, but can also be different rare earth metals.

In a special embodiment, the tetravalent metal Me4+ is selected from the group comprising silicon and/or germanium and/or tin and/or titanium and/or zirconium and/or hafnium. In particular, the oxides from the subgroup elements titanium, zirconium and hafnium themselves influence the dielectric material properties of the glass ceramic mass. In particular, these oxides influence the formation of the crystallization products. The oxides of the main group elements silicon, germanium and tin principally support a glassiness of the glass material. These oxides are used to control the viscosity temperature characteristic of the glass material.

In a special embodiment, the pentavalent metal Me5+ is selected from the group comprising bismuth and/or vanadium and/or niobium and/or tantalum. It also holds true here that oxides from the subgroup elements vanadium, niobium and tantalum (niobium pentoxide Nb₂O₅ or tantalum pentoxide Ta₂O₅ for example) directly influence the dielectric material properties. In particular, these oxides influence the formation of the crystallization products and thus indirectly the material properties. An oxide of bismuth as the main group element primarily supports the glassiness of the glass material.

In a further embodiment, the glass material contains at least one oxide with at least one further metal Mex, which is selected from the group comprising aluminum and/or magnesium and/or calcium and/or strontium and/or barium and/or copper and/or zinc. The further metal Mex can be present as a separate oxidic phase. The glassiness of the glass material can be stabilized by using the oxides aluminum trioxide (Al₂O₃), magnesium oxide (MgO), calcium oxide (CaO), strontium oxide (SrO) and barium oxide (BaO).

In a special embodiment, in addition to barium as a bivalent metal the oxide ceramic contains a doping of at least one further bivalent metal Me2+. In particular, in this situation the further bivalent metal Me2+ is selected from the group comprising copper and/or zinc. For example, the oxide ceramic having the composition BaRek₂Ti₄O₁₂ is doped with zinc. The bivalent metal Me2+ controls the dielectric material properties of the oxide ceramic. During sintering, in particular during a further treatment of the glass ceramic at higher temperatures, partial dissolution of the oxide ceramic in the glass melt can occur, with subsequent crystallization. It has become apparent that it is particularly advantageous if the glass material or an oxide of the glass material is doped with the bivalent metal Me2+ which also occurs in the oxide ceramic. The same also applies to other crystalline additions in the glass material. An oxide of an alkaline earth metal as a bivalent metal Me2+ increases the basicity of the glass material and thus a reactivity of the glass material with respect to a basic oxide ceramic. The composition of the oxide ceramic is therefore largely maintained during the compression process. It has become apparent that it is particularly advantageous if the oxide ceramic is doped with a bivalent metal Me2+ which also occurs in the glass material. In particular, zinc is to be mentioned here as a bivalent metal Me2+.

In a special embodiment, 100% by volume of the glass ceramic mass is composed of a ceramic proportion of the oxide ceramic which is selected from the range between 20% by volume inclusive to 60% by volume inclusive, and a glass proportion of the glass material which is selected from the range between 80% by volume inclusive to 40% by volume inclusive. In particular, the ceramic proportion is selected from the range between 30% by volume inclusive to 50% by volume inclusive and the glass proportion is selected from the range between 70% by volume inclusive to 50% by volume inclusive. With regard to these compositions, compression takes place primarily by viscous flow.

In particular, the oxide ceramic and/or the glass material contain a powder with a mean particle size (D₅₀ value) which is selected from the range between 0.8 μm inclusive and 3.0 μm inclusive. The mean particle size is also referred to as half-value particle size. The oxide ceramic and the glass material are each present as a powder of such a type. The mean particle size in particular lies between 1.5 μm and 2.0 μm. It has become apparent that with a particle size from the aforementioned range it is possible to exercise good control over a possible reactive eluation of individual constituents of the oxide ceramic or of crystalline additions in the glass material. Advantageously, the particle size does not exceed 3 μm in order to allow vitrification of the glass ceramic mass to take place.

Normally, in order to reduce the sintering temperature and to increase the permittivity of the glass ceramic mass, lead oxide (PbO) is added to the glass material. With regard to the present invention, the lead oxide proportion and/or cadmium oxide proportion of the glass ceramic mass and/or of the oxide ceramic and/or of the glass material is a maximum 0.1%, in particular a maximum of 1 ppm. By preference, with regard to environmental considerations, the proportion of lead oxide and cadmium oxide is almost zero. This is achieved by the present invention without significant restriction of the material properties of the glass ceramic mass.

In particular, the glass ceramic mass exhibits a maximum vitrification temperature of 850° C., and in particular a maximum of 800° C. In this situation, in particular, a glass ceramic mass is accessible with a permittivity which is selected from the range between 20 inclusive and 80 inclusive, a quality which is selected from the range between 300 inclusive and 5000 inclusive, and a Tf value which is selected from the range between −20 ppm/K inclusive and +20 ppm/K inclusive. With these material properties, the glass ceramic mass is very well suited for use in microwave technology.

According to a second aspect of the invention, a ceramic body using a previously described glass ceramic mass is specified. In particular, the ceramic body has at least one elementary metal MeO which is selected from the group comprising gold and/or silver and/or copper. By preference, the ceramic body is a ceramic multilayer body. The previously described glass ceramic mass is used to manufacture the ceramic body. In particular, a ceramic body in the form of a ceramic multilayer body can be manufactured in this manner. The glass ceramic mass is used in particular in ceramic film blanks in LTCC technology. In this way, glass ceramic masses are made available to the LTCC technology, having excellent material properties for the manufacture of microwave technology components. In addition, the glass ceramic mass which sinters at a low temperature can be used in order to suppress the lateral shrinkage occurring during the manufacture of a ceramic multilayer body.

To summarize, the following advantages result from the invention:

The composition of the glass ceramic mass using oxide ceramic and glass material is selected such that compression takes place primarily by viscous flow and crystallization products are formed during and/or after compression.

The composition of the oxide ceramic remains essentially constant during sintering of the glass ceramic mass. The material properties of the glass ceramic mass can thus be very well predetermined.

By means of suitable (oxidic) additions to the oxide ceramic and to the glass material, the sintering behavior of the glass ceramic mass and the material properties of the glass ceramic mass can be set almost as desired. It is thus possible, for example, to set permittivity, quality and Tf value over a wide range whilst retaining a low vitrification temperature.

Almost complete compression (vitrification) of the glass ceramic mass can be achieved below 850° C., as a result of which the ceramic mass is suitable for use in LTCC technology. In combination with glass ceramic mass in particular, which compresses at a higher temperature, a lateral shrinkage of below 2% can be achieved in a multistage sintering process.

Compression is achieved without the use of lead oxide and/or cadmium oxide.

The invention will be described in the following with reference to an embodiment and the associated drawing. The drawing shows a schematic cross-section, not to scale, of a ceramic body with the glass ceramic mass in a multilayer construction.

According to the embodiment, the glass ceramic mass 11 is a powder consisting of an oxide ceramic and a powder of a glass material. The oxide ceramic has the formal composition BaRek₂Ti₄O₁₂. The rare earth metal is neodymium. The oxide ceramic is doped with a bivalent metal Me2+ in the form of zinc. In order to manufacture the oxide ceramic, appropriate quantities of barium oxide, titanium dioxide and neodymium trioxide are mixed together with approximately one % by weight zinc oxide, calcinated or sintered, and subsequently ground to produce the corresponding powder.

The glass material has the following composition: 35.0% mol % boron trioxide, 23.0 mol % lanthanum trioxide and 42 mol % titanium dioxide. Moreover, alkaline earth metal oxides and zirconium dioxide at below 5% by weight are mixed with the glass material, whereby the ratio between boron trioxide and the sum of the oxides of the tetravalent metals titanium and zirconium is approximately 0.75.

100% by volume of the glass ceramic mass is composed of 35% by volume of the ceramic material and 65% by volume of the glass material. Ceramic material and glass material have a D₅₀ value of 1.0 μm. The vitrification temperature of the glass ceramic mass is 760° C.

During firing of the glass ceramic mass at a certain firing temperature the glass ceramic mass compresses. In addition, the crystallization product titanium dioxide is formed, which acts as a component serving to set the Tf value. Crystalline titanium dioxide at 15% by weight is obtained.

Depending on the firing temperature of the ceramic mass, the following dielectric material properties are set for the glass ceramic mass (at 6 GHz):

At a firing temperature of 790° C. the result is a permittivity of 34, a quality of 400 and a Tf value of −163 ppm/K. At a firing temperature of 820° C. the result is a permittivity of 32, a quality of over 1000 and a Tf value of −4 ppm. A firing regime which results in the specified values consists in a first heating phase having a heating rate of 2 K/min to a temperature of 500° C., a first dwell time of the temperature of 30 minutes, a second heating phase having a heating rate of 10 K/min, a second dwell time of 5 K/min and a cooling phase of 5 K/min to room temperature.

The glass ceramic mass 11 described is used in order to integrate a passive electrical component 6, 7 in the volume of a ceramic multilayer body 1 with the aid of LTCC technology. The passive electrical component 6, 7 consists of the elementary metal MeO silver. In order to produce the multilayer body 1, a composite is produced from ceramic film blanks with the glass ceramic mass 11 and Heratape® film blanks with the ceramic mass 12 which is different from the glass ceramic mass 12. The ceramic layers 3 and 4 of the ceramic multilayer body 1 are created from the ceramic film blanks together with the glass ceramic mass 11 as a result of the sintering process. The ceramic layers 2 and 5 result from the Heratape® film blanks. In the composite, at a firing temperature of 860° C. (vitrification temperature of the Heratape® film blanks) a permittivity of 30, a quality of over 1000 and a Tf value of +8 ppm/K are achieved for the glass ceramic mass. At a firing temperature of 900° C. a permittivity of 28, a quality of over 1000 and a Tf value of +142 are obtained.

1. Glass ceramic mass
comprising at least one oxide ceramic, containing barium, titanium and at least one rare earth metal Rek, and
at least one glass material, containing at least one oxide with boron and at least one oxide with at least one tetravalent metal Me4+,
characterized in that
the glass material contains at least one oxide with at least one rare earth metal Reg.

2. Glass ceramic mass according to claim 1, whereby the glass material contains at least one oxide with at least one pentavalent metal Me5+.

3. Glass ceramic mass
comprising at least one oxide ceramic, containing barium, titanium and at least one rare earth metal Rek, and
at least one glass material, containing at least one oxide with boron,
characterized in that the glass material contains
at least one oxide with at least one pentavalent metal Me5+, and
at least one oxide with at least one rare earth metal Reg.

4. Glass ceramic mass according to claim 3, whereby the glass material contains at least one oxide with at least one tetravalent metal Me4+.

5. Glass ceramic mass according to one of claims 1 though 4, whereby the oxide ceramic has a formal composition BaRek₂Ti₄O₁₂.

6. Glass ceramic mass according to one of claims 1 though 5, whereby the rare earth metal Rek
and/or the rare earth metal Reg is selected from the group comprising lanthanum and/or neodymium and/or samarium.

7. Glass ceramic mass according to one of claims 1, 2 and 4 though 6, whereby the tetravalent metal Me4+ is selected from the group comprising silicon and/or germanium and/or tin and/or titanium and/or zirconium and/or hafnium.

8. Glass ceramic mass according to one of claims 2 though 7, whereby the pentavalent metal Me5+ is selected from the group comprising bismuth and/or vanadium and/or niobium and/or tantalum.

9. Glass ceramic mass according to one of claims 1 though 8, whereby the glass material contains at least one oxide with at least one further metal Mex, which is selected from the group comprising aluminum and/or magnesium and/or calcium and/or strontium and/or barium and/or copper and/or zinc.

10. Glass ceramic mass according to one of claims 1 though 9, whereby in addition to barium as a bivalent metal the oxide ceramic contains a doping of at least one further bivalent metal Me2+.

11. Glass ceramic mass according to claim 10, whereby the further bivalent metal Me2+ is selected from the group comprising copper and/or zinc.

12. Glass ceramic mass according to one of claims 1 though 11, whereby 100% by volume of the glass ceramic mass is composed of a ceramic proportion of the oxide ceramic which is selected from the range between 20% by volume inclusive to 60% by volume inclusive, and a glass proportion of the glass material which is selected from the range between 80% by volume inclusive to 40% by volume inclusive.

13. Glass ceramic mass according to claim 12, whereby the ceramic proportion is selected from the range between 30% by volume inclusive to 50% by volume inclusive and the glass proportion is selected from the range between 70% by volume inclusive to 50% by volume inclusive.

14. Glass ceramic mass according to one of claims 1 though 13, whereby the oxide ceramic and/or the glass material contain a powder with a mean particle size which is selected from the range between 0.8 μm inclusive and 3.0 μm inclusive.

15. Glass ceramic mass according to one of claims 1 though 14, whereby a lead oxide proportion and/or a cadmium oxide proportion of the glass ceramic mass and/or of the oxide ceramic and/or of the glass material is a maximum 0.1%, in particular a maximum of 1 ppm.

16. Glass ceramic mass according to one of claims 1 though 15, with a maximum vitrification temperature of 850° C., in particular a maximum of 800° C.

17. Glass ceramic mass according to claim 16, with
a permittivity which is selected from the range between 15 inclusive and 80 inclusive,
a quality which is selected from the range between 300 inclusive and 5000 inclusive, and
a Tf value which is selected from the range between −20 ppm/K inclusive and +20 ppm/K inclusive.

18. Ceramic body using a glass ceramic mass according to one of claims 1 though 17.

19. Ceramic body according to claim 18, with at least one elementary metal MeO which is selected from the group comprising gold and/or silver and/or copper.

20. Ceramic body according to claim 18 or 19, whereby the ceramic body is a ceramic multilayer body.
